(19) United States
(12) Patent Application Publication
(10) Pub. No.: US 2003/0076270 A1
(43) Pub. Date: Apr. 24, 2003

(54) On-vehicle antenna

(76) Inventor: Fumihiro Okamoto, Saitama (JP)

Correspondence Address: George R Pettit, Connoly Bove Lodge & Hutz, P O Box 19088, Washington, DC, 20036-3425, US

(21) Appl. No.: 10/239,695

(22) PCT Filed: Jan. 22, 2002
(86) PCT No.: PCT/JP02/00406

(30) Foreign Application Priority Data
Feb. 16, 2001 (JP) 2001-039754

(51) Int. Cl. H01Q 1/32

(52) U.S. Cl. 343/713; 343/711

(57) ABSTRACT

With the aim of forming a waterproof structure without using a sealing material or filling material, the circumferential edge of the base main body part 4a is fitted in a first ring-form groove 5d in the pad main body part 5a. Next, the cover main body part 6a is fitted in a second ring-form groove 5e in the pad main body part 5a. Fastening screws are passed through from beneath the base main body part 4a, and are screwed into bosses 6d and 6e formed inside the cover main body part 6a. As a result, the second ring part 5c is fastened in place by being clamped between the lower end of the cover main body part 6a and the upper surface of the base main body part 4a. Accordingly, the base main body part 4a and cover main body part 5a can be fastened together in a water-tight manner.

### TECHNICAL FIELD

The present invention relates to a vehicular antenna which is suitable for use as a roof antenna that is attached to the roof of a vehicle body.

### BACKGROUND ART

Various types of antennas are used as antennas that are attached to the roofs of vehicle bodies; however, in the case of a vehicle body, the reception sensitivity can be increased if the antenna is attached to the roof located in the highest position of the vehicle body. Accordingly, vehicular antennas 101 that are attached to the roofs of automobiles 100 as shown in FIG. 11 have been used in the past. Furthermore, since an FM radio and an AM radio are generally installed inside the vehicle body, an antenna that can receive both the FM radio band and AM radio band is convenient; accordingly, such vehicular antennas 101 are generally devised so that these antennas can receive two radio bands in common.

Such a vehicular antenna 101 is equipped with at least an antenna element and an antenna case to which the antenna element is detachably attached. Furthermore, a base pad consisting of flexible rubber or plastic is mounted on the lower part of the antenna case so that the antenna case can be attached to the roof in a water-tight manner. Prior examples of the construction of the antenna case in such a vehicular antenna 101 are shown in sectional views in FIG. 12.

In the antenna case of the vehicular antenna 101 shown in FIG. 12(a), a fastening screw part 106b to which the antenna element is detachably attached is formed as an integral unit on the upper portion of a plastic cover part 106 whose lower portion is open. The antenna case is constructed by fastening a metal antenna base 104 to the lower portion of the cover main body part 106a in this cover part 106. As a result, the opening in the lower end of the cover part 106 is closed so that an accommodating space is formed inside. The cover main body part 106a and antenna base 104 are fastened together by passing a plurality of fastening screws through [the antenna base 104] from the undersurface of the antenna base 104, and screwing these screws into bosses 106d and 106e formed on the inside surface of the cover main body part 106a. An attachment part which is used to attach the vehicular antenna 101 to the roof is formed as an integral part of the antenna base 104 so that this attachment part protrudes from the undersurface of the antenna base 104.

Furthermore, when the vehicular antenna 101 is attached to the roof, the undersurface of the antenna base 104 faces against the roof, and if rain or the like enters the space between the antenna base 104 and the roof, the water that has invaded via the through-hole formed in roof and along the attachment part that extends into the interior of the vehicle body will enter the interior of the vehicle body. Accordingly, the entry of water into the interior of the vehicle body is prevented by mounting a base pad 105 consisting of flexible rubber or plastic on the lower portion of the antenna case. Furthermore, an O-ring 107 is disposed on the circumferential edge portion of the upper surface of the antenna base 104, and the antenna case is provided with a waterproof structure by causing the lower end of the cover main body part 106a to abut against the surface of the O-ring 107. Moreover, an O-ring 108 is mounted on the root of the attachment part that protrudes from the undersurface of the antenna base 104, and water is also prevented from invading the interior of the vehicle body by means of this structure.

Next, another antenna case in the vehicular antenna shown in FIG. 12(b) will be described. Since this antenna case differs from the antenna case shown in FIG. 12(a) only in terms of the waterproof structure that is used, only this waterproof structure will be described.

In the waterproof structure of the antenna case shown in FIG. 12(b), water is prevented from entering the interior of the vehicle body by mounting a base pad 105 consisting of flexible rubber or plastic on the lower portion of the antenna case. Furthermore, the accommodating space in the antenna case formed by the antenna base 104 and the cover main body 106a is filled with a filling material 109 so that the antenna case has a waterproof structure. Moreover, an O-ring 108 is mounted on the root of the attachment part that protrudes from the undersurface of the antenna base 104, and water is also prevented from invading the interior of the vehicle body by means of this structure. Next, still another antenna case in the vehicular antenna shown in FIG. 12(c) will be described. Since this antenna case differs from the antenna case shown in FIG. 12(a) only in terms of the waterproof structure that is used, only this waterproof structure will be described.

In the waterproof structure of the antenna case shown in FIG. 12(c), water is prevented from entering the interior of the vehicle body by mounting a base pad 105 consisting of flexible rubber or plastic on the lower portion of the antenna case. Furthermore, the joint area between the antenna base 104 and the cover main body part 106a is coated with a sealing material 110 so that both of these parts are fastened together, thus providing the antenna case with a waterproof structure. Moreover, an O-ring 108 is mounted on the root of the attachment part that protrudes from the undersurface of the antenna base 104, and water is also prevented from invading the interior of the vehicle body by means of this structure.

However, in all of these antenna cases used in prior vehicular antennas, the base pad 105 is mounted on the lower portion of the antenna case. Accordingly, the following problem arises: specifically, the base pad 105 may fall from the antenna case, or a positional deviation of the base pad 105 may occur, during transportation or attachment of the vehicular antenna. Furthermore, when a base pad 105 that has thus fallen from the antenna case is attached to the antenna case, this base pad 105 may be attached in the wrong position, since no positioning means are provided.

Furthermore, in the case of a waterproof structure in which an O-ring is disposed between the antenna base and the lower end of the cover main body part, or in which the interior of the antenna case is filled with a filling material, such an O-ring or filling material is required, and filling work is also required. Moreover, after such filling has been performed, the antenna case cannot be disassembled.

Furthermore, in the case of a waterproof structure in which a sealing material 110 is applied as a coating, the sealing material 110 may be squeezed out if the amount of sealing material 110 that is applied is large, so that wiping work is required. On the other hand, if the coating amount is too small, the required waterproof performance cannot be obtained. Furthermore, time is required for drying following the application of the sealing material 110 as a coating.

Accordingly, it is an object of the present invention to provide a vehicular antenna in which there is no falling of the base pad from the antenna case, or positional deviation of the base pad. Furthermore, it is also an object of the present invention to provide a vehicular antenna with a waterproof structure that does not use a sealing material or filling material.

### DISCLOSURE OF THE INVENTION

In order to achieve the abovementioned objects, the vehicular antenna of the present invention comprises an antenna element, an antenna case which consists of a cover part whose undersurface is open and a substantially planar antenna base which is attached so that this antenna base covers the open surface of the abovementioned cover part, and in which the abovementioned antenna element can be mounted and an accommodating space is formed inside, and a base pad consisting of a substantially ring-form pad main body part which is mounted on the circumferential edge of the lower portion of the abovementioned antenna case, wherein the abovementioned antenna base is fastened to the above-mentioned cover part in a state in which the abovementioned pad main body part is mounted on the abovementioned antenna base, so that a ring part which is formed so that this ring part protrudes from the inner circumferential surface of the abovementioned pad main body part is fastened in place by being clamped between the lower end of the above-mentioned cover part and the upper surface of the abovementioned antenna base.

Furthermore, the abovementioned vehicular antenna of the present invention may also be devised so that a plurality of projecting parts are formed on the upper surface of the abovementioned antenna base, abutment parts which abut against these projecting parts are formed so that these abutment parts protrude from the inner circumferential surface of the abovementioned cover, and the compression of the abovementioned ring part in the abovementioned base pad by the lower end of the abovementioned cover part is regulated as a result of the abovementioned abutment parts abutting against the abovementioned projecting parts when the above-mentioned cover part is fastened to the abovementioned antenna base.

Furthermore, in the abovementioned vehicular antenna of the present invention, a rib may be formed on the lower end of the abovementioned cover part so that this rib protrudes from the undersurface of the cover part.

Furthermore, in the abovementioned vehicular antenna of the present invention, a ring-form rib may be formed so that this rib protrudes from one surface of the abovementioned ring part in the abovementioned pad main body part, and the antenna may be devised so that the lower end of the above-mentioned cover part is caused to abut against this ring-form rib.

Furthermore, in the abovementioned vehicular antenna of the present invention, a ring-form groove into which the outer circumferential edge of the abovementioned antenna base is inserted may be formed in the inner circumferential surface of the abovementioned pad main body part.

Furthermore, in the abovementioned vehicular antenna of the present invention, positioning engaging parts which are engaged with the abovementioned projecting parts formed on the abovementioned antenna base when the abovementioned pad main body part is mounted on the abovementioned antenna base may be formed in the ring part of the abovementioned pad main body part.

Thus, in the present invention, since the ring part which is formed so that this ring part protrudes from the inner circumferential surface of the ring-form pad main body part is fastened in place by being clamped between the lower end of the cover part and the upper surface of the antenna base, the pad main body part can be prevented from falling off of the antenna case or showing any positional deviation. Furthermore, since the ring part in the pad main body part is clamped by the lower end of the cover part and the upper surface of the antenna base, the antenna case can be provided with a waterproof structure.

Furthermore, since [the antenna] is devised so that the degree to which the ring part is compressed as a result of being clamped by the lower end of the cover part and the upper surface of the antenna base is regulated by the projecting parts and abutment parts, the crushing of the ring part to a greater degree than is necessary can be prevented, so that the waterproof properties can be maintained over a long period of time.

Furthermore, the waterproof properties can be improved by forming a rib on the lower end of this cover part or the upper surface of a second ring part. Moreover, since positioning means for the antenna base are disposed on the pad main body part, assembly can be accomplished without an positional deviation.

### BRIEF DESCRIPTION OF THE DRAWINGS

FIG. 1 is a diagram which shows the overall construction of a vehicular antenna constituting an embodiment of the present invention;

FIG. 2 is an exploded assembly diagram which shows the construction of the antenna case and base pad in a vehicular antenna constituting an embodiment of the present invention;

FIG. 3(a) is a sectional view showing the construction of the antenna case and base pad in a vehicular antenna constituting an embodiment of the present invention;

FIG. 3(b) is an enlarged view of part A showing the construction of the antenna case and base pad in a vehicular antenna constituting an embodiment of the present invention;

FIG. 3(c) is an enlarged view of part B showing the construction of the antenna case and base pad in a vehicular antenna constituting an embodiment of the present invention;

FIG. 4(a) is a plan view showing the detailed construction of the cover part in a vehicular antenna constituting an embodiment of the present invention;

FIG. 4(b) is a front view showing the detailed construction of the cover part in a vehicular antenna constituting an embodiment of the present invention;

FIG. 4(c) is a bottom view showing the detailed construction of the cover part in a vehicular antenna constituting an embodiment of the present invention;

FIG. 5(a) is a sectional view that cuts approximately through the center of the cover part in a vehicular antenna constituting an embodiment of the present invention;

FIG. 5(b) is a partial enlarged view which shows the detailed construction of the cover part in a vehicular antenna constituting an embodiment of the present invention;

FIG. 6(a) a plan view which shows the detailed construction of the antenna base in a vehicular antenna constituting an embodiment of the present invention;

FIG. 6(b) is a sectional front view which shows the detailed construction of the antenna base in a vehicular antenna constituting an embodiment of the present invention;

FIG. 6(c) is a bottom view which shows the detailed construction of the antenna base in a vehicular antenna constituting an embodiment of the present invention;

FIG. 7(a) is a left-side view which shows the detailed construction of the antenna base in a vehicular antenna constituting an embodiment of the present invention;

FIG. 7(b) is a right-side view which shows the detailed construction of the antenna base in a vehicular antenna constituting an embodiment of the present invention;

FIG. 8(a) is a plan view which shows the detailed construction of the base pad in a vehicular antenna constituting an embodiment of the present invention;

FIG. 8(b) is a front view which shows the detailed construction of the base pad in a vehicular antenna constituting an embodiment of the present invention;

FIG. 8(c) is a bottom view which shows the detailed construction of the base pad in a vehicular antenna constituting an embodiment of the present invention;

FIG. 9(a) is a sectional side view which shows the detailed construction of the base pad in a vehicular antenna constituting an embodiment of the present invention;

FIG. 9(b) is a sectional front view which shows the detailed construction of the base pad in a vehicular antenna constituting an embodiment of the present invention;

FIG. 9(c) is partial enlarged view which shows the detailed construction of the base pad in a vehicular antenna constituting an embodiment of the present invention;

FIG. 10 is an exploded assembly diagram which shows the construction of the cover part and base pad in another vehicular antenna constituting an embodiment of the present invention;

FIG. 11 is a diagram which shows a prior vehicular antenna attached to a roof;

FIG. 12(a) is a sectional view which shows the construction of one antenna case in a prior vehicular antenna;

FIG. 12(b) is a sectional view which shows the construction of another antenna case in a prior vehicular antenna; and

FIG. 12(c) is a sectional view which shows the construction of still another antenna case in a prior vehicular antenna.

### BEST MODE FOR CARRYING OUT THE INVENTION

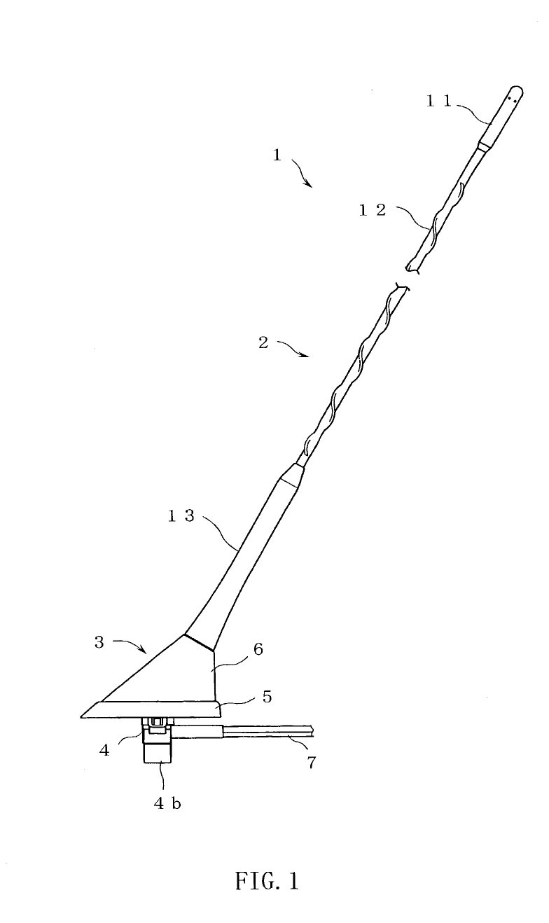

The overall construction of one embodiment of the vehicular antenna of the present invention is shown in FIG. 1.

As is shown in FIG. 1, the vehicular antenna 1 of the embodiment of the present invention shown in FIG. 1 is formed as an antenna that is attached to the roof of an automobile. This vehicular antenna 1 is constructed from an antenna element 2 and an antenna case 3 in which the antenna element 2 is screw-mounted in a detachable manner. The antenna element 2 is constructed from a flexible antenna base part 13 that can bend when a load is received from a lateral direction, an element part 12 that extends from the antenna base part 13, and an antenna top 11 that is disposed on the tip end of the element part 12. A coil is contained inside the antenna base part 13, and the antenna element 2 can operate at multiple frequencies as a result of the action of this coil. A helical projection is formed on the element part 12 in order to prevent wind noise that tends to occur during high-speed operation [of the vehicle]. Furthermore, although this is not shown in the figures, an antenna attachment screw which is used to fasten the antenna element 2 to the antenna case 3 by screwing is formed on the lower end of the antenna base part 13 so that this screw protrudes from the antenna base part 13. This antenna attachment screw also acts to feed power to the antenna element 2.

The antenna case 3 is constructed from a plastic cover part 6 which is open at the bottom, and a metal antenna base 4 which is fastened in place so that this antenna base 4 covers the open surface of the cover part 6. An accommodating space that can accommodate a circuit board is formed inside the antenna case 3, and a frequency division circuit and an amplifying circuit that amplifies the frequency-divided reception signal are incorporated into this circuit board. This circuit board is fastened by soldering or the like to a ground fitting not shown in the figures, and this ground fitting is fastened to the upper surface of the antenna base 4. A cable 7 which leads out received signals and supplies power to the circuit board is lead out from the antenna case 3. Furthermore, an attachment part 4b which is used to attach the vehicular antenna 1 to the roof passing this attachment part 4b through a through-hole formed in the roof and screw-fastening an attachment nut [on the attachment part 4b] from the interior of the vehicle is formed as an integral unit on the undersurface of the antenna base 4 so that this attachment part 4b protrudes from the undersurface of the antenna base 4. Furthermore, a flexible rubber or plastic base pad 5 is mounted on the lower part of the antenna case 3 so that the antenna case 3 can be attached to the roof in a water-tight manner, and without scratching the antenna case 3. As will be described later, this antenna pad 5 is fastened in place as a result of a portion of this antenna pad being clamped between the lower end of the cover part 6 and the upper surface of the antenna base 4. As a result, the base pad 5 can be prevented from falling off of the antenna case 3 or showing any positional deviation.

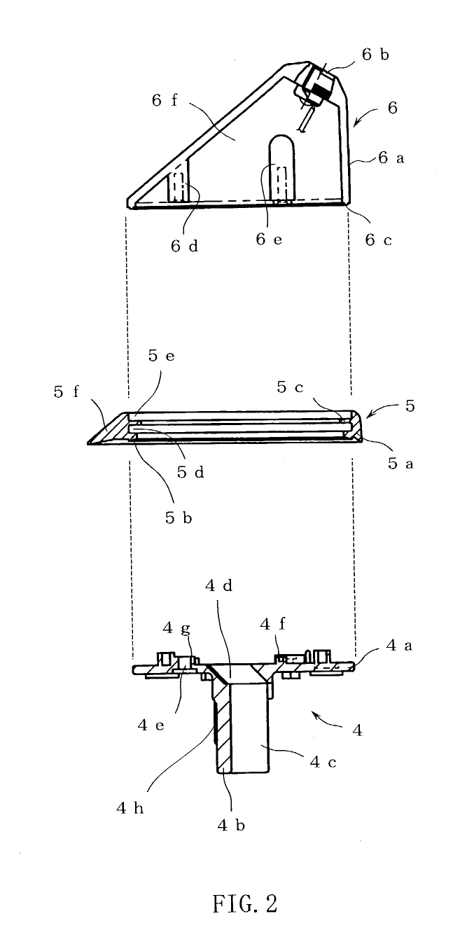

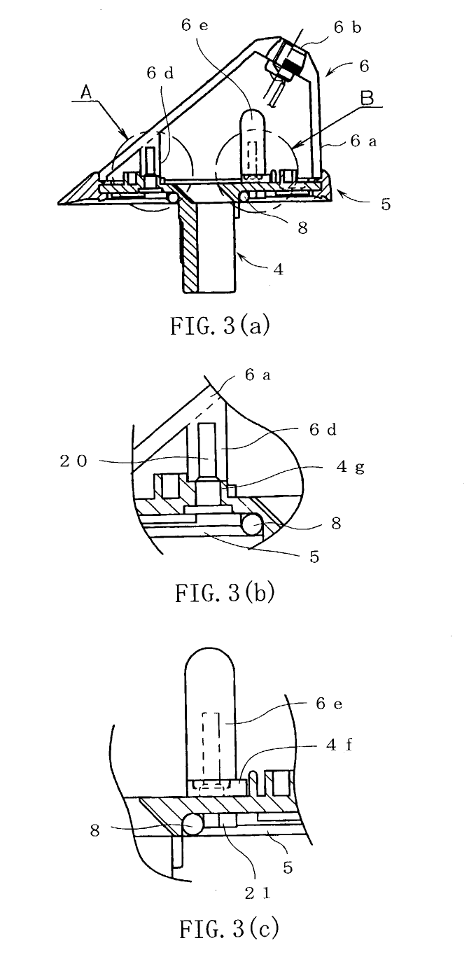

In the vehicular antenna 1 of the present invention, since the characterizing construction of the antenna is a construction that depends on the antenna case 3 and base pad 5, these parts will be described below with reference to FIGS. 2 and 3.

FIG. 2 is an exploded assembly diagram of the antenna case 3 in the vehicular antenna 1 of the present invention, and FIG. 3 shows a sectional view and partial enlarged views that illustrate the construction of the assembled antenna case 3. As is shown in these figures, the antenna case 3 is constructed so that the base pad 5 which is mounted on the circumferential edge of the antenna base 4 is fastened in place by being clamped between the antenna base 4 and cover part 6. The cover part 6 consists of a cover main body part 6a made of plastic which is open at the bottom; a fastening screw part 6b to which the antenna element 2 is detachably fastened by screwing is formed as an integral unit on the upper portion of this cover part 6. Furthermore, a rib 6c is formed on the lower end surface of the cover main body part 6a so that this rib 6c protrudes from the cover main body part 6a. Moreover, a boss 6d and a pair of bosses 6e are formed inside the cover main body part 6a.

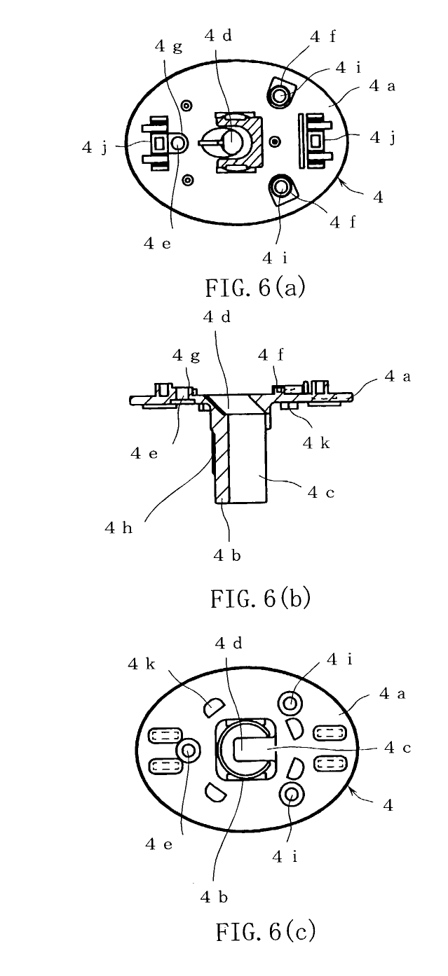

Meanwhile, the antenna base 4 which is made of metal is constructed from a base main body part 4a which is formed in a substantially elliptical shape, and an attachment part 4b which is formed as an integral part of the base main body part 4a so that this attachment part 4b protrudes downward from the undersurface of the base main body part 4a. Three screw through-holes 4e and 4i (see FIG. 6) are formed in the base main body part 4a, and projecting parts 4g and 4f are formed on the upper surface [of the base main body part 4a] so that these projecting parts surround the screw through-holes 4e and 4i. Furthermore, a through-hole 4d which is used to lead the cable 7 to the outside is formed in the approximate center of the base main body part 4a. Moreover, a screw part 4h to which a fastening nut is fastened by screwing is formed on the outer circumferential surface of the attachment part 4b, and the through-hole 4d is extended and formed substantially along the central axis of the attachment part 4b. A cut-out part 4c is formed by cutting substantially along the central axis from the outer circumferential surface of the attachment part 4b so that this cut-out part 4c reaches the through-hole 4d. The cable 7 can be led out from the cut-out part 4c; as a result, the cable 7 led out from the through-hole 4d can be disposed more or less parallel to the undersurface of the base main body part 4a.

Furthermore, the base pad 5 consists of a pad main body part 5a which is formed substantially in the shape of a ring, and a first ring part 5b and second ring part 5c are formed in two stages that are substantially parallel on the inner circumferential surface of the pad main body part 5a. As a result, a first ring-form groove 5d is formed between the first ring part 5b and second ring part 5c, and a second ring-form groove 5e is formed on the upper part of the second ring part 5c. Furthermore, a skirt part 5f is disposed on the lower portion of the pad main body part 5a, and is arranged so that this skirt part adheres tightly to the roof when placed on the roof.

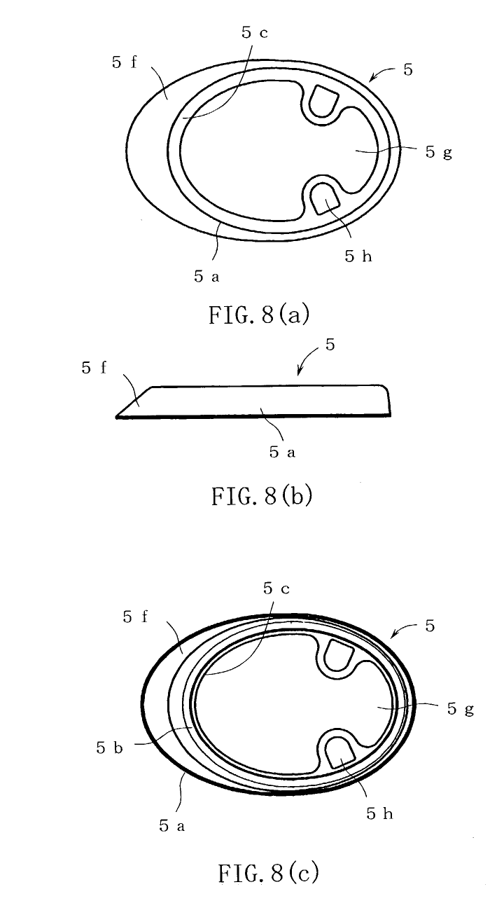

When the antenna case 3 is to be assembled, the base pad 5 constructed as described above is mounted on the antenna base 4. In this case, positioning is accomplished by engaging the pair of projecting parts 4f with engaging holes 5h (described later; see FIG. 8) formed in the second ring part 5c, and the circumferential edge portion of the base main body part 4a is mounted inside the first ring-form groove 5d of the pad main body part 5a. In this state, the cover part 6 is mounted from above the base pad S. In this case, the lower portion of the cover main body part 6a is mounted inside the second ring-form groove 5e of the pad main body part 5a. Next, fastening screws 20 are passed through the screw through-holes 4e and 4i of the antenna base 4 from below, and are respectively screwed into the boss 6d and a pair of bosses 6e formed in the cover main body part 6a. As a result, the second ring part 5c of the base pad 5 is clamped by the antenna base 4 and cover part 6 so that these parts are fastened into an integral unit, thus making it possible to prevent the base pad 5 from falling off of the antenna case 3 or showing any positional deviation.

The antenna case assembled in this manner is the antenna case 3 shown in FIG. 3(a); the construction of the area A in the vicinity of the boss 6d formed in the cover main body part 6a is shown as a partial enlarged view in FIG. 3(b), and the construction of the area B in the vicinity of the bosses 6e is shown as a partial enlarged view in FIG. 3(c).

As is shown in FIG. 3(a), since the first ring part 5c of the base pad 5 is interposed and compressed between the lower end of the cover main body part 6a and the upper surface of the base main body part 4a, the antenna case 3 can be provided with a waterproof structure. In this case, since a rib 6c is formed so that this rib 6c protrudes from the lower end surface of the cover main body part 6a, secure waterproofing can be obtained as a result of the action of the rib 6c. Furthermore, an O-ring 8 is mounted on the root of the attachment part 4b that protrudes from the undersurface of the antenna base 4, and the entry of water into the interior of the vehicle body is also prevented by this O-ring 8.

Furthermore, as is shown in FIG. 3(b), a fastening screw 20 is passed through the base pad 5 from below and screwed into the boss 6d. In this case, on the upper surface of the base pad 5, the upper end of the projecting part 4g formed around the screw through-hole 4e abuts against the lower end of the boss 6d. Furthermore, as is shown in FIG. 3(c), fastening screws 21 are passed through the base pad 5 from below and screwed into the bosses 6e. In this case, on the upper surface of the base pad 5, the upper ends of the projecting parts 4f formed around the screw through-holes 4i abut against the lower ends of the bosses 6e. Specifically, when the lower ends of the bosses 6d and 6e abut against the upper ends of the projecting parts 4g and 4f, the screw attachment accomplished by the fastening screws 20 and 21 is completed; accordingly, the compression of the second ring part 5c of the base pad 5 that is clamped by the lower end of the cover main body part 6a and the upper surface of the base main body part 4a is regulated. As a result of such a construction, the crushing of the second ring part 5c to an extent that is greater than necessary can be prevented, so that a waterproof function can be exhibited over a long period of time.

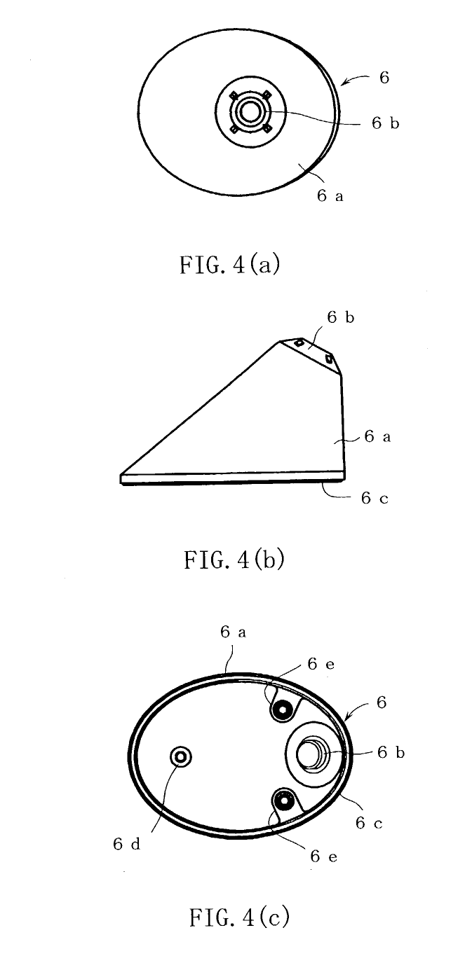

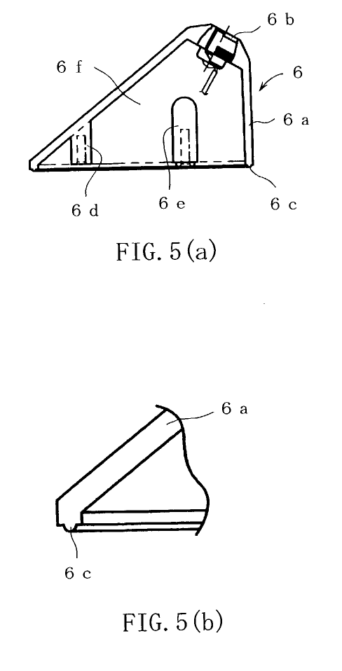

Next, the detailed construction of the cover part 6 is shown in FIGS. 4 and 5. FIG. 4(a) is a plan view of the cover part 6, FIG. 4(b) is a front view, and FIG. 4(c) is a bottom view. FIG. 5(a) is a sectional view that cuts through the approximate center of the cover part 6, and FIG. 5(b) is an enlarged view of a portion of the cover part 6.

As is shown in these figures, the cover part 6 consists of a plastic cover main body part 6a which is open at the bottom, and a fastening screw part 6b on which the antenna element 2 is detachably mounted by screwing is formed as an integral unit on the upper portion of this cover main body part 6a. Furthermore, as is shown in FIG. 5(b), a rib 6c is formed on the lower end surface of the cover main body part 6a so that this rib 6c protrudes [from this lower end surface]. Furthermore, as is shown in FIG. 4(c) a boss 6d and a pair of bosses 6e are formed on the inside of the cover main body part 6a. Moreover, the area inside the cover main body part 6a is used as an accommodating space 6f.

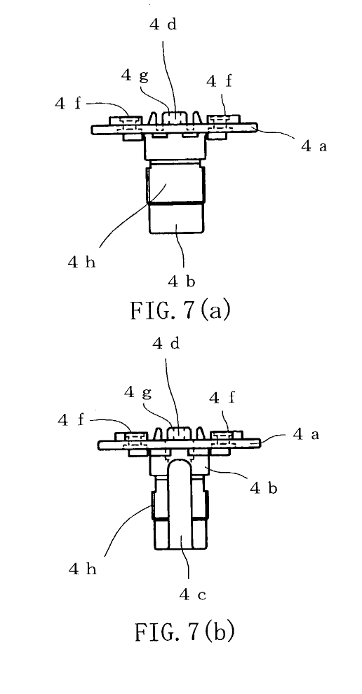

Next, the detailed construction of the antenna base 4 is shown in FIGS. 6 and 7. FIG. 6(a) is a plan view of the antenna base 4, FIG. 6(b) is a sectional front view that cuts through the approximate center of the antenna base 4, FIG. 6(c) is a bottom view of the antenna base 4, FIG. 7(a) is a left-side view of the same, and FIG. 7(b) is a right-side view of the same.

As is shown in these figures, the antenna base 4, which is made of metal, is constructed from a base main body part 4a which is formed in a substantially elliptical shape, and an attachment part 4b which is formed as an integral unit [with the base main body part 4a] so that this attachment part 4b protrudes downward from the undersurface of the base main body part 4a. As is shown in FIGS. 6(a) and 6(c), a screw through-hole 4e and a pair of screw through-holes 4i are formed in the upper surface of the base main body part 4a, and a projecting part 4g and a pair of projecting parts 4f are respectively formed so that these projecting parts surround the abovementioned screw through-holes 4e and 4i. Furthermore, a circuit board containing circuits that amplify and divide the frequency of the signal received by the antenna element 2 can be accommodated in the accommodating space 6f formed by the antenna base 4 and the cover part 6. This circuit board is fastened by soldering or the like to a ground fitting (not shown in the figures), and a pair of board fastening parts 4j which are used to fasten the ground fitting in an upright position are disposed on the upper surface of the base main body part 4a.

Furthermore, a through-hole 4d which is used to lead the cable 7 to the outside is formed in the approximate center of the base main body part 4a. This through-hole 4d is formed as an extension that runs more or less along the central axis of the attachment part 4b, and the system is arranged so that the cable 7 can be passed through this through-hole 4d. A screw part 4h on which a fastening nut is mounted by screwing is formed on the outer circumferential surface of the attachment part 4b. Furthermore, as is shown in FIGS. 6(c) and 7(b), a cut-out part 4c is formed by cutting more or less along the central axis from the outer circumferential surface of the attachment part 4b so that this cut-out part 4c reaches the through-hole 4d. The cable 7 can be led out from the cut-out part 4c; as a result, the cable 7 led out via the throughhole 4d can be disposed more or less parallel to the undersurface of the base main body part 4a. Furthermore, four projections 4k which are used in order to prevent the first ring part 5b of the base pad 5 that abuts against the roof from being crushed to an extent that is greater than necessary when the fastening nut is screwed onto the screw part 4h of the attachment part 4b from the inside of the vehicle body are formed on the undersurface of the base main body part 4a.

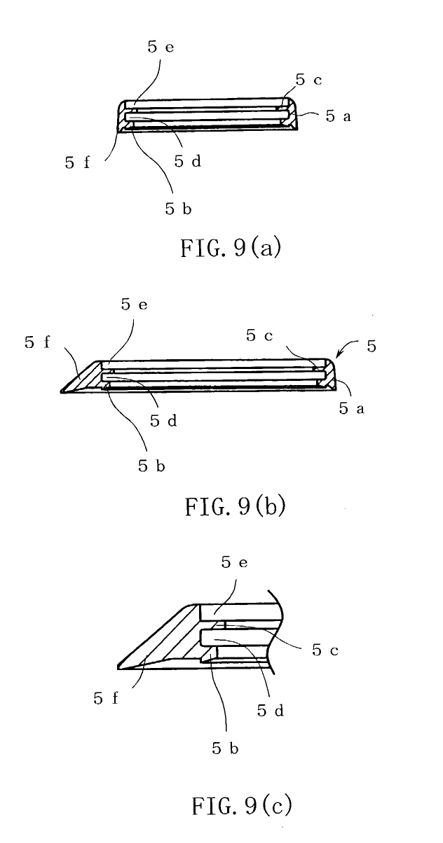

Next, the detailed construction of the base pad 5 is shown in FIGS. 8 and 9. FIG. 8(a) is a plan view of the base pad 5, FIG. 8(b) is a front view of the same, FIG. 8(c) is a bottom view of the same, FIG. 9(a) is a sectional side view that cuts through the approximate center of the base pad 5, FIG. 9(b) is a sectional front view of the base pad 5, and FIG. 9(c) is an enlarged view of one portion of the same.

The base pad 5 consists of a pad main body part 5a that is formed substantially in the shape of a ring; a mounting hole 5g is formed in the center of this base pad 5. A first ring part 5b and second ring part 5c are formed more or less parallel to each other in two stages on the inner circumferential surface of this mounting hole 5g. A pair of engaging holes 5h are formed in the second ring part 5c, and the areas around the circumferences of the engaging holes 5h are formed so that these circumferential areas protrude inward. These engaging holes 5h are arranged so that they can respectively engage with the pair of projecting parts 4f on the antenna base 4. As a result of this engagement, the base pad 5 can be positioned on the antenna base 4.

Furthermore, a first ring-form groove 5d is formed between the first ring part 5b and second ring part 5c, and a second ring-form groove 5e is formed on the upper portion of the second ring part 5c. The first ring-form groove 5d can mount the circumferential edge portion of the base main body part 4a, and [the apparatus] is arranged so that the lower portion of the cover part 6 can be mounted in the second ring-form groove 5e. Furthermore, a skirt part 5f is disposed on the lower portion of the pad main body part 5a, and is arranged so that this skirt part adheres tightly to the roof when placed on the roof and fastened in place. Moreover, the first ring part 5b is clamped and tightly fastened between the circumferential edge of the base main body part 4a and the roof when the fastening nut is screwed onto the screw part 4h of the attachment part 4b in the base main body part 4a from the interior of the vehicle body; as a result, water is prevented from entering the area inside the first ring part 5b.

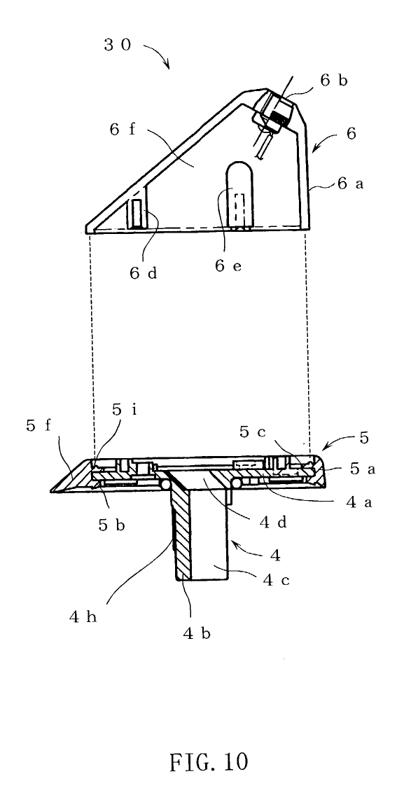

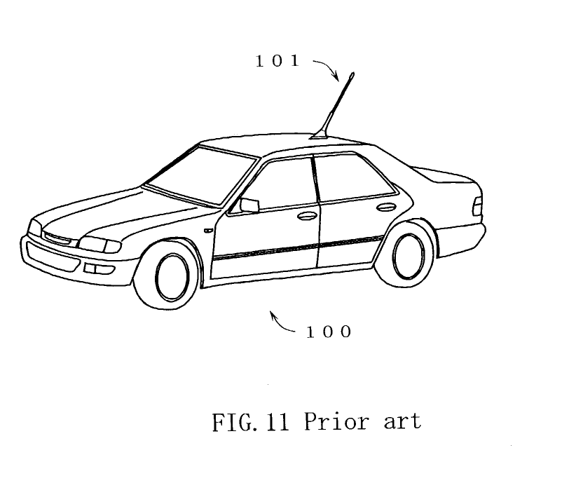

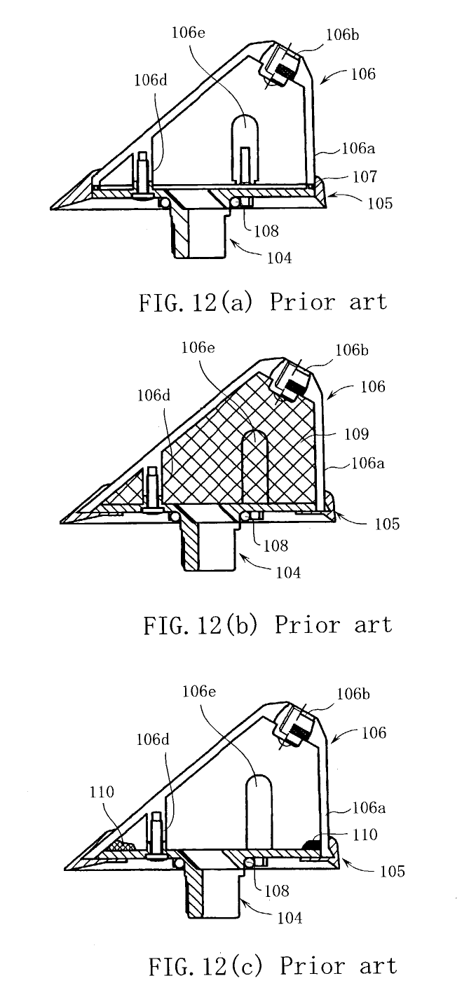

Next, the construction of a modified example of the antenna case in the vehicular antenna 1 of the present invention is shown in FIG. 10. In FIG. 10, the construction of the modified example of the antenna case 30 is shown in an exploded assembly diagram.

In the antenna case 3 of the vehicular antenna 1 of the present invention described above, a rib 6c was formed so that this rib 6c protruded from the lower end surface of the cover main body part 6a, and this rib 6c was pressed against the upper surface of the second ring part 5c in the pad main body part 5a. In the modified example of the antenna case 30 shown in FIG. 10, instead of the abovementioned construction, a ring-form rib 5i is formed on the upper surface of the second ring part 5c in the pad main body part 5a. Furthermore, this construction is arranged so that the lower end of the cover main body part 6a is pressed against the second ring part 5c, thus crushing the ring-form rib 5i when the cover part 6 is mounted on the antenna base 4. As a result, the antenna case 30 can be securely waterproofed by the action of the ring-form rib 5i. The remaining construction of this modified example of the antenna case 30 is the same as the construction of the abovementioned antenna case 3; accordingly, a description is omitted.

In the vehicular antenna 1 of the present invention, the antenna element 2 can be formed as a common antenna for two bands, i.e., the AM band and the FM band, or as a common antenna for three bands, with the telephone band added to the abovementioned two bands.

### INDUSTRIAL APPLICABILITY

In the present invention, as was described above, a ring part which is formed so that this ring part protrudes from the inner circumferential surface of a ring-form pad main body part is fastened in place by being clamped between the lower end of a cover part and the upper surface of an antenna base. Accordingly, the pad main body part can be prevented from falling off of the antenna case or showing any positional deviation. Furthermore, since the ring part of the pad main body part is clamped by the lower end of the cover part and the upper surface of the antenna base, the antenna case can be provided with a waterproof structure.

Furthermore, since the present invention is devised so that the degree to which the ring part is compressed as a result of being clamped by the lower end of the cover part and the upper surface of the antenna base can be regulated by projecting parts and abutment parts, crushing of the ring part to an extent that is greater than necessary can be prevented, so that waterproof properties can be maintained over a long period of time.

Furthermore, the waterproof properties can be improved by formed a rib on the lower end of the abovementioned cover part or on the upper surface of the second ring part. Moreover, since positioning means for the antenna base are disposed on the pad main body part, assembly can be accomplished without any positional deviation.

1. A vehicular antenna comprising:
an antenna element;
an antenna case which consists of a cover part whose undersurface is open and a substantially planar antenna base which is attached so as to cover the open surface of said cover part, and in which said antenna element can be mounted and an accommodating space is formed inside; and
a base pad consisting of a substantially ring-form pad main body part which is fitted on the circumferential edge of the lower portion of said antenna case;
said vehicular antenna being characterized in that said antenna base is fastened to said cover part in a state in which said pad main body part is fitted on said antenna base, so that a ring part which is formed so as to protrude from the inner circumferential surface of said pad main body part is fastened in place by being clamped between the lower end of said cover part and the upper surface of said antenna base.

2. The vehicular antenna according to claim 1, characterized in that a plurality of projecting parts are formed on the upper surface of said antenna base, and abutment parts which abut against these projecting parts are formed so as to protrude from the inner circumferential surface of said cover, whereby the compression of said ring part in said base pad by the lower end of said cover part is regulated when said cover part is fastened to said antenna base.

3. The vehicular antenna according to claim 1, characterized in that a rib is formed on the lower end of said cover part so as to protrude from the undersurface of said cover part.

4. The vehicular antenna according to claim 1, characterized in that a ring-form rib is formed so as to protrude from one surface of said ring part in said pad main body part, and the lower end of said cover part is caused to abut against said ring-form rib.

5. The vehicular antenna according to claim 1, characterized in that a ring-form groove into which the outer circumferential edge of said antenna base is inserted is formed in the inner circumferential surface of said pad main body part.

6. The vehicular antenna according to claim 2, which is characterized in that positioning engaging parts which are engaged with said projecting parts formed on said antenna base when said pad main body part is fitted on said antenna base are formed in the ring part of said pad main body part.
